(19) United States
(12) Patent Application Publication
(10) Pub. No.: US 2020/0160462 A1
(43) Pub. Date: May 21, 2020

(54) Streaming Device and Hotel Partnership

(71) Applicant: Daniel Clark, III, Bloomingdale, IL (US)

(72) Inventor: Daniel Clark, III, Bloomingdale, IL (US)

(21) Appl. No.: 16/197,823

(22) Filed: Nov. 21, 2018

(51) Int. Cl. G06Q 50/12; G06Q 30/06; H04L 29/06

(52) U.S. Cl. CPC G06Q 50/12; H04L 65/60; G06Q 30/0633

(57) ABSTRACT

This streaming device/hotel partnership business model will allow you to watch and enjoy familiar content and programming on a streaming device from the comfort of your hotel room, because your subscriptions will follow you. Further, it insures a well-known and reliable manner of purchasing online content such as games, television shows and movies. Or online shopping directly from the hotel's streaming device for last minute urgently needed or forgotten items, while on vacation or otherwise away from home.

This is a business method patent application presented by Daniel Clark III of Daycare Desktop Publishing LLC. It involves joining video streaming device companies into partnerships with the hotel industry. Currently, no such partnership presently exists. This business method must be protected prior to marketing this partnership to both industries. Nondisclosure agreements are impractical and are not accepted by most corporations. These streaming device-hotel partnerships or agreements shall be in the form of lawfully written, signed, and binding contracts. Revenue sharing and contract durations will be negotiable between each party.

According to the United States Patent and Trademark Office, the Business Methods Practice Area is part of Technology Center 3600 that handles Business Methods applications. The Business Methods Practice Area is comprised of three workgroups that include 3620, 3680, and 3690. The 3620 and the 3680 workgroups examine applications pertaining to incentive programs, coupons; operations research; electronic shopping; health care; point of sale, inventory, accounting; cost/price, reservations, shipping, and transportation; and business processing. The 3690 workgroup examines applications pertaining to finance/banking/insurance.

This patent application is therefore covered by Art Units 3625 and 3684 workgroups because it falls under the category of electronic shopping, point of sale, inventory, 3628 shipping, and 3629 business processing. Class/ Subclass 705/26.127.2 (Source USPTO)

Business Methods Workgroups 3620, 3680, 3690

Electronic Shopping Art Unit 3625 3684

### BRIEF SUMMARY OF THE INVENTION

Subscribers leave home. They go on vacation; attend conferences, conventions, visit people, and places all over the globe. This requires temporary living in a hotel environment. In this business model, your subscriptions follow you to your hotel room. This business model provides familiar and recognizable programming content while away from home, giving hotel guest's access to Netflix, Hulu, Direct TV Now, HBO Now, and Amazon Prime programming for example. National news channels in locations where the subscriber can easily find them as opposed to learning a new hotel menu or channel guide.

### DETAILED DESCRIPTION OF INVENTION

Any streaming device will be available to hotel guests as readily as any amenity. It will be attached and locked or otherwise secured to existing hotel furniture.

An Amazon Fire TV streaming device (for example) can be secured in the hotel room using the H-Squared's Amazon Fire TV mount by Rack Solutions.

This mount locks with a key securing the streaming device onto the hard surface of hotel furniture. Each unit can be accessed using the subscriber's username and password for each use.

Several implementation methods are available to accomplish this objective. There are various examples of existing methods for securing the Fire TV's inside each hotel room however, this business model deems any method that joins streaming devices in hotel rooms, lobby or public and private areas be included in this marriage of technologies and facilities and is not limited to this example alone. Streaming devices may have to be secured with locks or otherwise secured in each hotel room or elsewhere in the hotel that enables guests to use the streaming devices in this business model.

Most hotels already have wifi in place but may need to boost their megabytes per second for decent streaming rates. Or the internet signal can be brought to the individual rooms via Cat 5 or Cat 6 Ethernet cable, which has a maximum signal distance of 328 feet using full duplex (information goes both ways) point to point switching. This will give the hotel more control over the broadcast signal integrity from a central location and help guard against theft. Ultimately, the hotel guest is financially responsible for retaining the hotel's possession of the locked streaming device in each room. Most streaming devices have Ethernet adapters available. For security reasons, each streaming device must be geo-configured for use only in the assigned area.

The remote and streaming device will have to be digitally matched to prevent signal bleed into adjoining rooms. The hotel(s) should be responsible for the purchase and installation of the locking mechanism. The installations can be accomplished with hotel maintenance personnel presently on premises. Streaming device companies should be responsible for purchase and provisioning of the streaming device and remote.

This is a business partnership plan between any streaming device company and any hotel or hotel chain in North America or Globally. This joint service will be promoted through advertising of print and digital media by both the partnering hotel or hotel chain and any streaming device company. All promotional expenses shall be of a negotiable percentage rate and the sole responsibility of any streaming device company and any hotel or hotel chain entering into an agreement of this nature.

Percentage Partner Share: For verifiable financial clarity, it is best to have a separate and exclusive financial accounting system for this business model between the hotel(s) and the streaming device companies. The streaming device companies also can provide commercially configured streaming devices to the hotel(s) as assigned. We suggest any and all revenues and financial transactions resulting from this business plan be split between the streaming companies, the hotel(s), and the licensor.

### The Consumer Market

There are over 117 million streaming memberships or subscribers with Netflix alone. (Source Netflix annual report dated Feb. 17, 2018)

Amazon has over 100 million Prime members globally. (Source Amazon annual report)

Hulu has just reached 17 million subscribers in 2017. (Source hulu.com)

This represents a total of over 235 million subscribers.

### The Hotel Market

Research shows that there are over 5 million hotel rooms in North America alone and many more globally. The website (str.com) collects performance data from over 58,000 hotels representing more than 7.9 million rooms globally.

(Source) (statista.com)

Global hotel revenues 2018 are $497 Billion dollars and $208 Billion dollars in the United States.

### Streaming Device BACKGROUND

This is an example of two of the many streaming devices available for inclusion in this business model patent application. However, this business model patent application is not limited to these examples.

Roku started back in 2002 as an audio streamer via the SoundBridge platform. In 2007, it also started out being owned by Netflix. In the end, Netflix made the decision to spin off their set-top box into its own company that would end up being called Roku. Netflix would be available on Roku, and Netflix would also pursue other devices that would offer the Netflix app. Roku was then free to put other services, like Amazon Video, on the Roku streaming stick. (Note) HTTP or hypertext transfer protocol is used by the World Wide Web. This protocol defines how messages are formatted, transmitted and what actions web servers and browsers should take in response to various commands.

Amazon Fire TV (1st Generation) Unveiled on Apr. 2, 2014. In 2015, the Amazon Fire TV (2nd Generation) was released with improved processor speed and 4K UHD support. Amazon Fire TV is also available in the United Kingdom, Germany, and Japan and launched in India in 2016. On Nov. 19, 2014, Amazon released a smaller version of the Fire TV called the Fire TV Stick.

Codenamed “Montoya”, it is an HDMI-port plug-in device that replicates much of the functionality of the larger Fire TV. On Oct. 3, 2018, Amazon has announced on Fire TV Stick 4K, with Alexa Voice Activated Remote.

### Suggestion for Streaming Device Locking Mechanisms

This business method is not limited to this suggestion, but includes any method to secure a streaming device to a hotel environment a part of this business method.

H-Squared's Amazon Fire TV Wall Mount is designed to wall mount your Amazon Fire TV device with your television set and keeps it hidden behind the entertainment system if desired.

The company proclaims that they can custom design streaming device locks and manufacture them the same day. Therefore, steaming locks can be mass-produced for the Apple TV, Amazon Fire Stick, Roku Streaming Stick, Google Chromecast, and many more streaming devices.

Because of the locking enclosure's open-design, a streaming device can be mounted in any orientation without interfering with the Fire TV's peripheral ports or Bluetooth signal. For additional security, a barrel lockable version is available to deter theft. The Fire TV wall mount includes all necessary mounting hardware, including screws and drywall anchors.

The mount is designed for streaming device use while keeping your device locked. Space saving, increased organization and lockable, it does not allow the streaming device to be removed without the key. This mount is powder-coated black and steel built. This mount is an easy and convenient installation with hardware included.

Made from durable 16 GA steel

All mounting hardware is included

Includes 2 sets of keys

### A Brief Description of Several Currently Available Streaming Devices

### (Previously Presented) (Photographs Removed)

### The Amazon Fire TV HDMI Plugin and Remote

This device is used by the subscriber for enjoying entertainment content and online purchases. It plugs into the HDMI port of a television. The remote connects or pairs to the device and controls the device using Bluetooth technology.

### The Roku Player HDMI Plugin and Remote

This device is used by the subscriber for enjoying entertainment content and online purchases. It plugs into the HDMI port of a television. The remote connects to or pairs the device and controls the device using Bluetooth technology.

### The Apple TV 4K and Remote

This device is used by the subscriber for enjoying entertainment content and online purchases. It plugs into the HDMI port of a television. The remote connects or pairs to the device and controls the device using Bluetooth technology.

### The Google Chromecast

This device is used by the subscriber for enjoying entertainment content and online purchases. It plugs into the HDMI port of a television. Your cellular phone pairs to the device in order to control it via Bluetooth.

### The Amazon Fire Stick HDMI Streaming Device and Remote

This device is used by the subscriber for enjoying entertainment content and online purchases. It plugs into the HDMI port of a television. The remote connects or pairs to the device and controls the device using Bluetooth technology.

### The Xbox Console and Controller

Primarily used by consumers for online or stand-alone gaming. It also facilitates the online streaming of entertainment content. The remote connects or pairs to the device and controls the device using Bluetooth technology.

### The PlayStation Console and Controller

Primarily used by consumers for online or stand-alone gaming. It also facilitates the online streaming of entertainment content. The remote connects or pairs to the device and controls the device using Bluetooth technology.

Some of the streaming devices that are available right now for home use but not hotel use are Amazon Fire TV, Google Chromecast, Amazon Fire TV Stick, Apple TV 4K, and Roku Streaming Stick. While gaming devices such as The PlayStation 4 Pro, Microsoft Xbox One S would offer a good addition to hotel lobbies or rooms and is included in this business model application.

### BRIEF DESCRIPTION OF DRAWING

### Flowchart (1)

### As Previously Described in Detailed Description of Invention

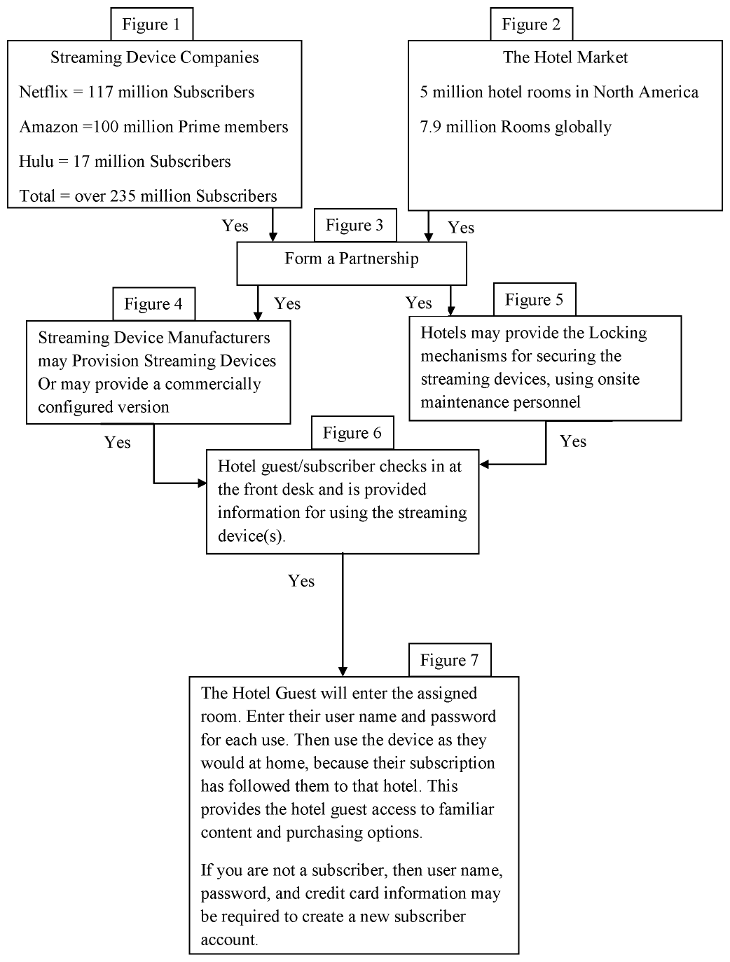

FIG. 1 The various streaming device companies have in excess of 235 million subscribers. (Yes)

FIG. 2 This represents various hotel chains or individual hotels totaling over 5 million rooms in North America. (Yes)

FIG. 3 These two industries form a partnership (Yes)

FIG. 4 The streaming device may companies' provision streaming devices. (Yes)

FIG. 5 The hotel may provide the locking mechanisms for securing the streaming devices, using onsite personnel. (Yes)

FIG. 6 As a result of the partnership, guests/subscriber checking into participating hotel front desks is given information on using the available streaming device(s). (Yes)

FIG. 7 The hotel guest enters the assigned room where they would then enter their username and password for each use as they would at home because their subscription has followed them to that hotel. This provides the hotel guest access to familiar content and purchasing options. If you are not a subscriber, the user name, password, and credit card information may be required to create a new subscriber account.

1. (canceled)

2. Your streaming subscriptions follow you to your hotel room.

3. Provides additional online purchasing options for items or content from your hotel room.

4. (canceled)

5. (canceled)
